(19) United States
(12) Patent Application Publication
(10) Pub. No.: US 2004/0078197 A1
(43) Pub. Date: Apr. 22, 2004

(54) Method and device for determining the quality of a speech signal

(76) Inventors: John Gerard Beerends, Pb Hengstdijk (NL); Andries Pieter Hekstra, Ne Eindhoven (NL)

Correspondence Address: MICHAELSON AND WALLACE, PARKWAY 109 OFFICE CENTER, 328 NEWMAN SPRINGS RD, P O BOX 8489, RED BANK, NJ, 07701

(21) Appl. No.: 10/468,087

(22) PCT Filed: Mar. 1, 2002
(86) PCT No.: PCT/EP02/02342

(30) Foreign Application Priority Data
Mar. 13, 2001 (EP) 01200945.2

(51) Int. Cl. G10L 19/14

(52) U.S. Cl. 704/225

(57) ABSTRACT

Objective measurement methods and devices for predicting perceptual quality of speech signals degraded in speech rocessing/transporting systems may have poor prediction results for degraded signals including extremely weak or silent portions. Improvement is achieved by applying a first scaling step in a pre-processing stage with a first scalins factor (S(Y+Δ), which is a function of the reciprocal value of the power of the output signal increased by an adjustment value (Δ), and by a second scaling step with a second scaling factor (S^{α}(Y+Δ); S^{αi}(Y+Δᵢ), with i=1, 2), which is substantially equal to the first scaling factor raised to an exponent having a adjustment value (α) between zero and one. The second scaling step may be carried out on various locations in the device. The adjustment values are adjusted using test signals with well defined subjective quality scores.

### A. BACKGROUND OF THE INVENTION

The invention lies in the area of quality measurement of sound signals, such as audio, speech and voice signals. More in particular, it relates to a method and a device for determining, according to an objective measurement technique, the speech quality of an output signal as received from a speech signal processing system, with respect to a reference signal. Methods and devices of such type are known, e.g., from References [1,-,5] (for more bibliographic details on the References, see below under C. References). Methods and devices, which follow the ITU-T Recommendation P.861 or its successor Recommendation P.862 (see References [6] and [7]), are also of such a type. According to the present known technique, an output signal from a speech signals processing and/or transporting system, such as wireless telecommunications systems, Voice over Internet Protocol transmission systems, and speech codecs, which is generally a degraded signal and whose signal quality is to be determined, and a reference signal, are mapped on representation signals according to a psycho-physical perception model of the human hearing. As a reference signal, an input signal of the system applied with the output signal obtained may be used, as in the cited references. Subsequently, a differential signal is determined from said representation signals, which, according to the perception model used, is representative of a disturbance sustained in the system present in the output signal. The differential or disturbance signal constitutes an expression for the extent to which, according to the representation model, the output signal deviates from the reference signal. Then the disturbance signal is processed in accordance with a cognitive model, in which certain properties of human testees have been modelled, in order to obtain a time-independent quality signal, which is a measure of the quality of the auditive perception of the output signal.

The known technique, and more particularly methods and devices which follow the Recommendation P.862, have, however, the disadvantage that severe distortions as caused by extremely weak or silent portions in the degraded signal, and which contain speech in the reference signal, may result in a quality signal, which possesses a poor correlation with subjectively determined quality measurements, such as mean opinion scores (MOS) of human testees. Such distortions may occur as a consequence of time clipping, i.e. replacement of short portions in the speech or audio signal by silence e.g. in case of lost packets in packet switched systems. In such cases the predicted quality is significantly higher than the subjectively perceived quality.

### B. SUMMARY OF THE INVENTION

An object of the present invention is to provide for an improved method and corresponding device for determining the quality of a speech signal, which do not possess said disadvantage.

The present invention has been based, among other things, on the following observation. The gain of a system under test is generally not known a priori. Therefore in an initialisation or pre-processing phase of the main step of processing the output (degraded) signal and the reference signal a scaling step is carried out, at least on the output signal by applying a scaling factor for an overall or global scaling of the power of the output signal to a specific power level. The specific power level may be related to the power level of the reference signal in techniques such as following Recommendation P.861, or to a predefined fixed level in techniques which follow Recommendation P.862. The scaling factor is a function of the reciprocal value of the square root of the average power of the output signal. In cases in which the degraded signal includes extremely weak or silent portions, this reciprocal value increases to large numbers. It is this behaviour of the reciprocal value of such a power related parameter, that can be used to adapt the distortion calculation in such a manner that a much better prediction of the subjective quality of systems under test is possible.

A further object of the present invention is to provide a method and a device of the above kind, which comprise a better controllable scaling operation and means for such better controllable scaling operation, respectively.

This and other objects are achieved by introducing in a method and device of the above kind an additional, second scaling step carried out by applying a second scaling factor, using at least one adjustment parameter, but preferably two adjustment parameters. In the preferred case the second scaling factor is a function of a reciprocal value of a power related parameter raised to an exponent with a value corresponding to a first adjustment parameter, in which function the power related parameter is increased with a value corresponding to a second adjustment parameter. The second scaling step may be carried out in various stages of the method and device.

The use of a scaling factor, which is a function of a reciprocal value of a power related parameter of a kind as the known square root of the average power of the output signal, has still a further shortcoming, since there exist still other cases which will lead to unreliable speech quality predictions. One of such cases is the following. Two degraded speech signals, which are the output signals of two different speech signal processing systems under test, and which have the same input reference signal, may have the same value for the average power. E.g. one of the signals has a relative large power during only a short time of the total speech signal duration and extremely low or zero power elsewhere, whereas the other signal has a relative low power during the total speech duration. Such degraded signals may have mainly the same prediction of the speech quality, whereas they may differ considerably in the subjectively experienced speech quality.

A still further object of the present invention is to provide a method and a device of the above kind, in which a scaling factor is introduced, which will lead to reliable speech quality predictions also in cases of different degraded signals having mainly equal power average values as mentioned.

This and still other objects are achieved by introducing in the first and/or second scaling operations of the method and device of the above kind the use of two new scaling factors based on power related parameters which differ from the average signal power. A first new scaling factor is a function of a new power related parameter, called signal power activity (SPA), which is defined as the total time duration during which the power of a signal concerned is above or equal to a predefined threshold value. The first new scaling factor is defined for scaling the output signal in the first scaling operation, and is a function of the reciprocal value of the SPA of the output signal. Preferably the first new scaling factor is a function of the ratio of the SPA of the reference signal and the SPA of the output signal. This first new scaling factor may be used instead of or in combination (e.g. in multiplication) with the known scaling factor based on the average signal power. The second new scaling factor is derived from what may be called a local scaling factor, i.e. the ratio of the instantaneous powers of the reference and output signals, in which the adjustment parameters are introduced on the local level. A local version of the second new scaling factor may be applied in the second scaling operation as carried out directly to the, still time-dependent, differential signal during and in a combining stage of the method and device, respectively. A global version of the second new scaling factor is achieved by averaging at first the local scaling factor over the total duration of the speech signal, and then applying it in the second scaling operation as carried out during and in the signal combining stage, instead of or in combination with a scaling operation applying the scaling factor derived from the (known and/or first new) scaling factor applied in the first scaling operation.

The first new scaling-factor is more advantageous in cases of degraded speech signals with parts of extremely low or zero power of relative long duration, whereas the second new scaling factor is more advantageous for such signals having similar parts of relative short duration.

### C. REFERENCES

[1] Beerends J. G., Stemerdink J. A., “A perceptual speech-quality measure based on a psychoacoustic sound representation”, J.Audio Eng. Soc., Vol. 42, No. 3, December 1994, pp. 115-123;

[2] WO-A-96/28950;

[3] WO-A-96/28952;

[4] WO-A-96/28953;

[5] WO-A-97/44779;

[6] ITU-T Recommendation P.861, “Objective measurement of Telephone-band (330-3400 Hz) speech codecs”, June, 1996;

[7] ITU-T Recommendation P.862 (February, 2001), Series P:

Telephone Transmission Quality, Telephone Installations, Local Line Networks; Methods for objective and subjective assessment of quality—Perceptual evaluation of speech quality (PESQ), an objective method for end-to-end speech quality assessment of narrow-band telephone networks and speech codecs.

The References [1],-,[7] are incorporated by reference into the present application.

### D. BRIEF DESCRIPTION OF THE DRAWING

The invention will be further explained by means of the description of exemplary embodiments, reference being made to a drawing comprising the following figures:

FIG. 1 schematically shows a known system set-up including a device for determining the quality of a speech signal;

FIG. 2 shows in a block diagram a detail of a known device for determining the quality of a speech signal;

FIG. 3 shows in a block diagram a similar detail as shown in FIG. 2 of another known device;

FIG. 4 shows in a block diagram a similar detail as shown in FIG. 2 or FIG. 3, according to the invention;

FIG. 5 shows in a block diagram a device for determining the quality of a speech signal according to the invention, including a variant of the detail as shown in FIG. 4;

FIG. 6 shows in a part of the block diagram of FIG. 5 a variant of a detail of the device shown in FIG. 5;

FIG. 7 shows in a similar way as FIG. 6 a further variant.

### E. DESCRIPTION OF EXEMPLARY EMBODIMENTS

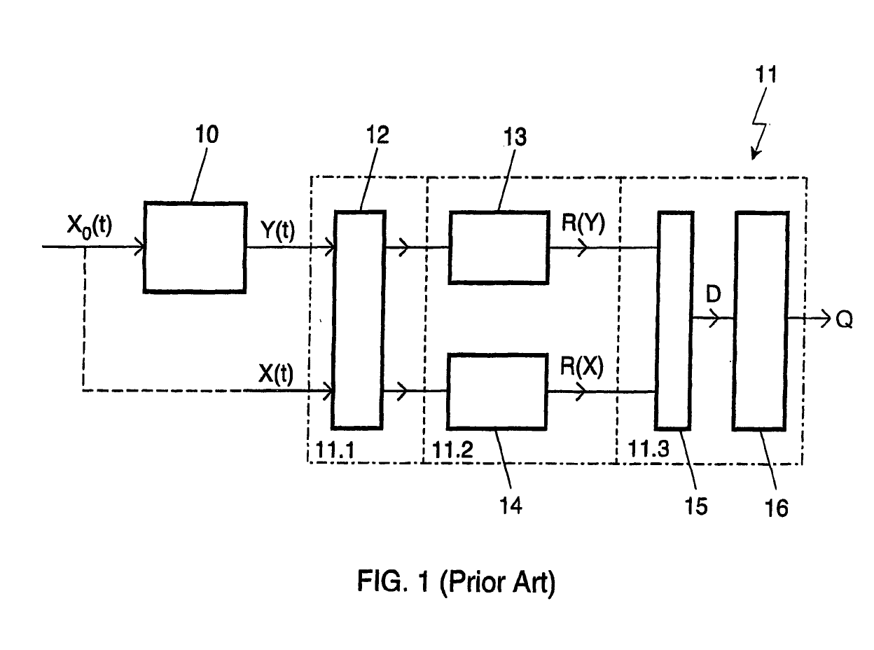

FIG. 1 shows schematically a known set-up of an application of an objective measurement technique which is based on a model of human auditory perception and cognition, such as one which follows any of the ITU-T Recommendations P.861 and P.862, for estimating the perceptual quality of speech links or codecs. It comprises a system or telecommunications network under test 10, hereinafter referred to as system 10 for briefness' sake, and a quality measurement device 11 for the perceptual analysis of speech signals offered. A speech signal X₀(t) is used, on the one hand, as an input signal of the network 10 and, on the other hand, as a first input signal X(t) of the device 11. An output signal Y(t) of the network 10, which in fact is the speech signal X₀(t) affected by the network 10, is used as a second input signal of the device 11. An output signal Q of the device 11 represents an estimate of the perceptual quality of the speech link through the network 10. Since the input end and the output end of a speech link, particularly in the event it runs through a telecommunications network, are remote, for the input signals of the quality measurement device use is made in most cases of speech signals X(t) stored on data bases. Here, as is customary, speech signal is understood to mean each sound basically perceptible to the human hearing, such as speech and tones. The system under test may of course also be a simulation system, which simulates e.g. a telecommunications network. The device 11 carries out a main processing step which comprises successively, in a pre-processing section 11.1, a step of pre-processing carried out by pre-processing means 12, in a processing section 11.2, a further processing step carried out by first and second signal processing means 13 and 14, and, in a signal combining section 11.3, a combined signal processing step carried out by signal differentiating means 15 and modelling means 16. In the pre-processing step the signals X(t) and Y(t) are prepared for the step of further processing in the means 13 and 14, the pre-processing including power level scaling and time alignment operations. The further processing step implies mapping of the (degraded) output signal Y(t) and the reference signal X(t) on representation signals R(Y) and R(X) according to a psycho-physical perception model of the human auditory system. During the combined signal processing step a differential or disturbance signal D is determined by the differentiating means 15 from said representation signals, which is then processed by modelling means 16 in accordance with a cognitive model, in which certain properties of human testees have been modelled, in order to obtain the quality signal Q.

Recently it has been experienced that the known technique, and more particularly the one of Recommendation P.862, has a serious shortcoming in that severe distortions as caused by extremely weak or silent portions in the degraded signal, and which are not present in the reference signal, may result in quality signals Q, which predict the quality significantly higher than the subjectively perceived quality and therefore possess poor correlations with subjectively determined quality measurements, such as mean opinion scores (MOS) of human testees. Such distortions may occur as a consequence of time clipping, i.e. replacement of short portions in the speech or audio signal by silence e.g. in case of lost packets in packet switched systems.

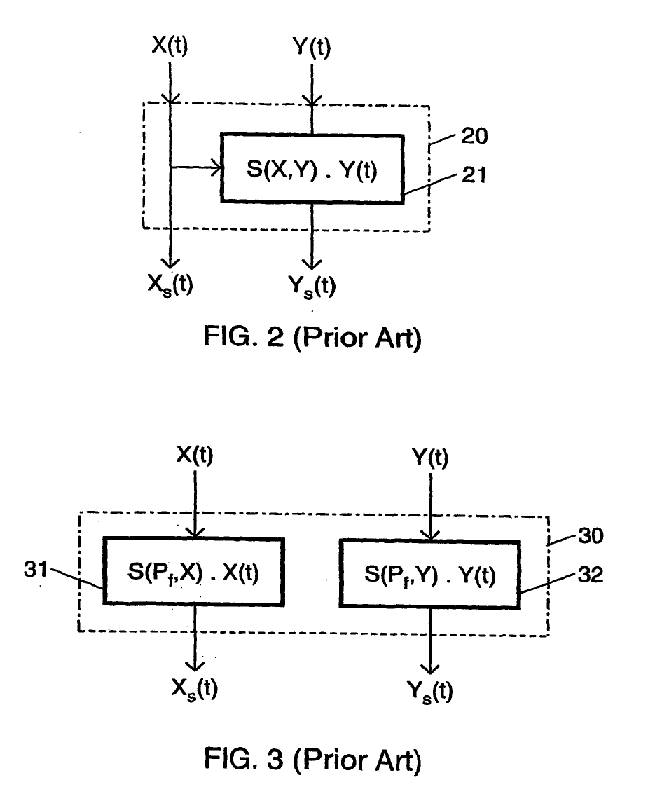

Since the gain of a system under test is generally not known a priori, during the initialisation or pre-processing phase a scaling step is carried out, at least on the (degraded) output signal by applying a scaling factor for scaling the power of the output signal to a specific power level. The specific power level may be related to the power level of the reference signal in techniques such as following Recommendation P.861. Scaling means 20 for such a scaling step has been shown schematically in FIG. 2. The scaling means 20 have the signals X(t) and Y(t) as input signals, and signals X_{S}(t) and Y_{S}(t) as output signals. The scaling is such that the signal X(t)=X_{S}(t) is unchanged and the signal Y(t) is scaled to Y_{S}(t)=S₁·Y(t) in scaling unit 21, applying a scaling factor:

S₁=S(X,Y)=\sqrt{P_{average}(X)/P_{average}(Y)} {1}

In this formula P_{average(X)} and P_{average(Y)} mean the time-averaged power of the signals X(t) and Y(t), respectively.

The specific power level may also be related to a predefined fixed level in techniques which may follow Recommendation P.862. Scaling means 30 for such a scaling step has been shown schematically in FIG. 3. The scaling means 30 have the signals X(t) and Y(t) as input signals, and signals X_{S}(t) and Y_{S}(t) as output signals. The scaling is such that the signal X(t) is scaled to X_{S}(t)=S₂·X(t) in scaling unit 31 and the signal Y(t) is scaled to Y_{S}(t)=S₃·Y(t) in scaling unit 32, respectively by applying scaling factors:

S₂=S(P_{f},X)=\sqrt{P_{fixed}/P_{average}(X)} {2}

and

S₃=S(P_{f},Y)=\sqrt{P_{fixed}/P_{average}(Y)} {3}

in which P_{fixed} (i.e. P_{f}) is a predefined power level, the so-called constant target level, and P_{average}(X) and P_{average}(Y) have the same meaning as given before.

In both cases scaling factors are used, which are a function of the reciprocal value of a power related parameter, i.e. the square root of the power of the output signal, for S₁ and S₃, or of the power of the reference signal, for S₂. In cases in which the degraded signal and/or the reference signal includes large parts of extremely weak or silent portions, such power related parameters may decrease to very small values or even zero, and consequently the reciprocal values thereof may increase to very large numbers. This fact provides a starting point for making the scaling operations, and preferably also the scaling factors used therein, adjustable and consequently better controllable.

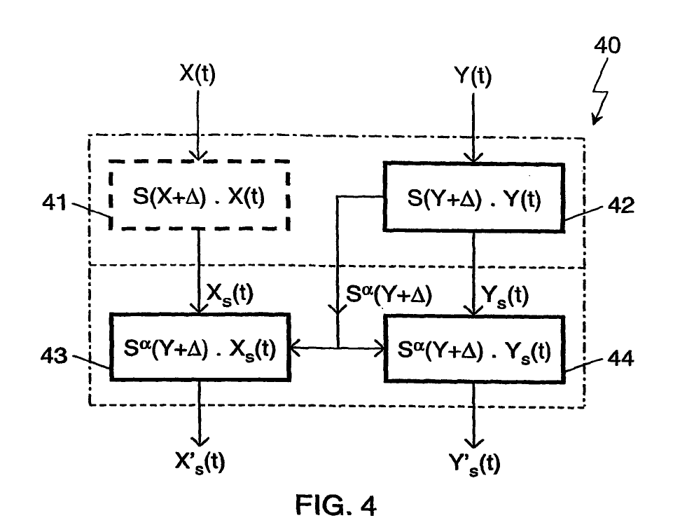

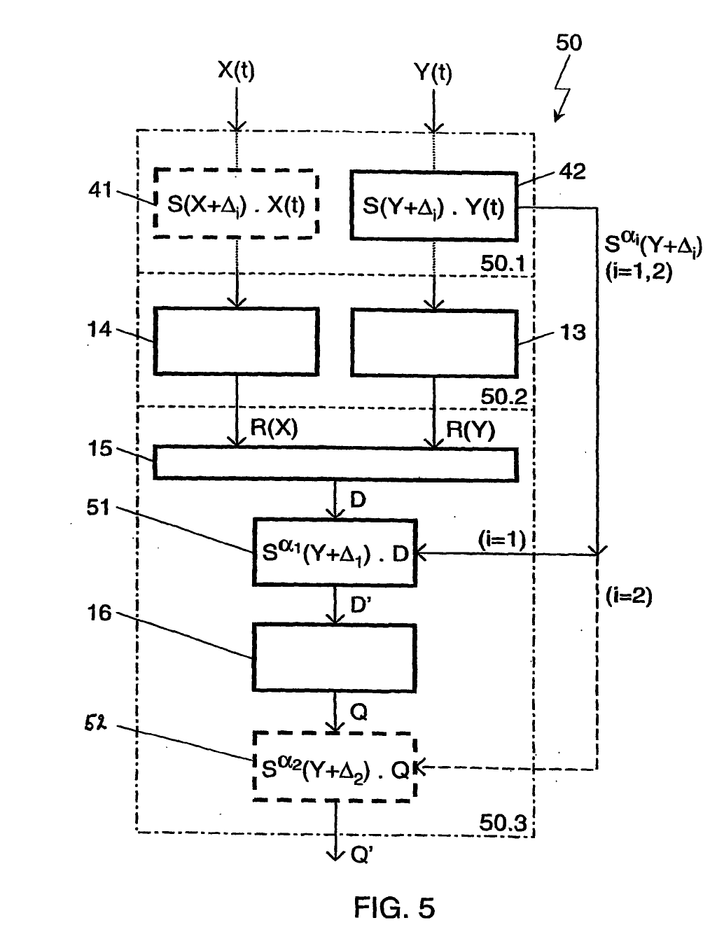

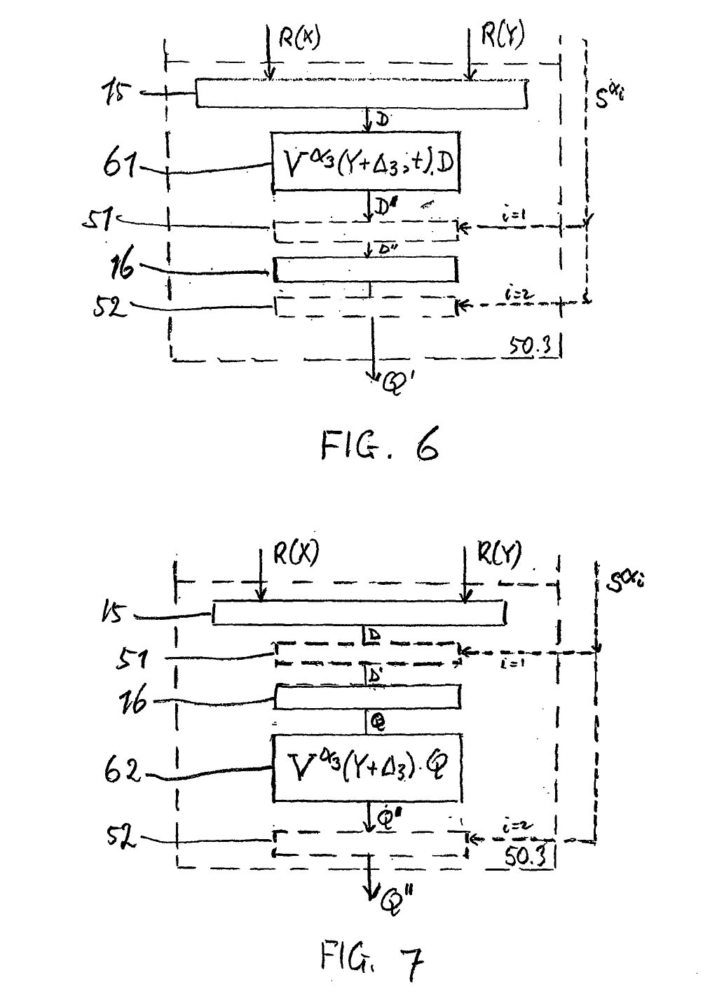

In order to achieve such a better controllability at first a further, second scaling step is introduced by applying a further, second scaling factor. This second scaling factor may be chosen to be equal to (but not necessary, see below) the first scaling factor, as used for scaling the output signal in the first scaling step, but raised to an exponent α. The exponent α is a first adjustment parameter having values preferably between zero and 1. It is possible to carry out the second scaling step on various stages in the quality measurement device (see below). Secondly a second adjustment parameter Δ, having a value≧0, may be added to each time-averaged signal power value as used in the scaling factor or factors, respectively in the first and second one of the two described prior art cases. The second adjustment parameter Δ has a predefined adjustable value in order to increase the denominator of each scaling factor to a larger value, especially in the mentioned cases of extremely weak or silent portions. The scaling factor(s) thus modified (for Δ≠0), or not (for Δ=0), is (are) used in the first scaling step of the initialisation phase in a similar way as previously described with reference to FIGS. 2 and 3, as well as in the second scaling step. Hereinafter three different ways are described with reference to FIG. 4 and FIG. 5, for which the second scaling factor is derived from the first scaling factor, followed by a description with reference to FIG. 6 and FIG. 7 of some ways in which this is not the case.

FIG. 4 shows schematically a scaling arrangement 40 for carrying out the first scaling step by applying modified scaling factors and the second scaling step. The scaling arrangement 40 have the signals X(t) and Y(t) as input signals, and signals X′_{S}(t) and Y′_{S}(t) as output signals. The first scaling step is such that the signal X(t) is scaled to X_{S}(t)=S′₂·X(t) in scaling unit 41 and the signal Y(t) is scaled to Y_{S}(t)=S′₃·Y(t) in scaling unit 42, respectively by applying modified scaling factors:

S′₁=S(Y+Δ)={square root over ((P_{average}(X)+Δ)/(P_{average}(Y)+Δ))} {1′}

for cases having a scaling step in accordance with FIG. 2, in which X_{S}(t)=X(t) (i.e. S(X+Δ)=1 in FIG. 4), and

S′₂=S(X+Δ)={square root over (P_{fixed}/(P_{average}(X)+Δ))} {2′}

and

S′₃=S(Y+Δ)={square root over (P_{fixed}/(P_{average}(Y)+Δ))} {3′}

for cases having a scaling step in accordance with FIG. 3.

The second scaling step is such that the signal X_{S}(t) is scaled to X′_{S}(t)=S₄·X_{S}(t) in scaling unit 43 and the signal Y_{S}(t) is scaled to Y′_{S}(t)=S₄·Y_{S}(t) in scaling unit 44, by applying scaling factor:

S₄=S^{α}(Y+Δ) {4}

The scaling factor S₄ may be generated by the scaling unit 42 and passed to the scaling units 43 and 44 of the second scaling step as pictured. Otherwise the scaling factor S₄ may be produced by the scaling units 43 and 44 in the second scaling step by applying the scaling factor S₃ as received from the scaling unit 42 in the first scaling step.

It will be appreciated that the first and second scaling steps carried out within the scaling arrangement 40 may be combined to a single scaling step carried out on the signals X(t) and Y(t) by scaling units, which are combinations respectively of the scaling units 41 and 43, and scaling units 42 and 44, by applying scaling factors which are the products of the scaling factors used in the separate scaling units. Such a combined scaling step, in which the parameters are chosen as −1<α≦0 and Δ≧0, will be equivalent to a case in which only the first scaling step is present, which applies a scaling factor in which the reciprocal value of the power related parameter is raised to an exponent corresponding to an adjustment parameter α′ with 0<(α′=1+α)≦1 and the power related parameter is increased with an adjustment value corresponding to the parameter Δ.

The values of the parameters α and Δ are adjusted in such a way that for test signals X(t) and Y(t) the objectively measured qualities have high correlations with the subjectively perceived qualities (MOS). Thus examples of degraded signals with replacement speech by silences up to 100% appeared to give correlations above 0.8, whereas the quality of the same examples as measured in the known way showed values below 0.5. Moreover there appeared indifference for cases for which the Recommendation P.862 was validated.

The values for the parameters α and Δ may be stored in the pre-processor means of the measurement device. However, adjusting of the parameter α may also be achieved by adding an amount of noise to the degraded output signal at the entrance of the device 11, in such a way that the amount of noise has an average power equal to the value needed for the adjustment parameter Δ in a specific case.

Instead of in the pre-processing phase the second scaling step may be carried out in a later stage during the processing of the output and reference signals. However the location of the second scaling step does not need to be limited to the stage in which the signals are processed separately. The second scaling step may also be carried out in the signals combining stage, however with different values for the parameters α and Δ. Such is pictured in FIG. 5, which shows schematically a measurement device 50 which is similar as the measurement device 11 of FIG. 1, and which successively comprises a pre-processing section 50.1, a processing section 50.2 and a signal combining section 50.3. The pre-processing section 50.1 includes the scaling units 41 and 42 of the first scaling step, the unit 42 producing the scaling factor S₄ (see formula {4}) indicated in the figure by S^{αi}(Y+Δᵢ), in which i=1,2 for a first and a second case, respectively.

In the first case (i=1) the second scaling step is carried out, in the signal combining section 50.3, by scaling unit 51 and by applying the scaling factor S₄=S^{α1}(Y+Δ₁), thereby scaling the differential signal D to a scaled differential signal D′=S^{α1}(Y+Δ₁)·D. Alternatively, in the second case (i=2) the second scaling step is carried out, again in the signal combining section 50.3, by scaling unit 52 and by applying the scaling factor S₄=S^{α2}(Y+Δ₂), thereby scaling the quality signal Q to a scaled quality signal Q′=S^{α2}(Y+Δ₂)·Q. For the parameters αᵢ and Δᵢ the same applies as what has been mentioned previously in relation to the parameters α and Δ. Instead of as an alternative, the scaling step of the second case (i=2) may be carried out also as a third scaling step additionally to the second scaling step of the first case (i=1), however with different suitable adjustment parameters.

Further improvements are achieved by introducing in the first and/or second scaling operations two new scaling factors based on power related parameters which differ from the average signal power.

A first new kind of scaling factor may be defined and applied in the first scaling step, and also in the second scaling step, which is based on a different parameter related to the power of the signal X(t) and/or the signal Y(t). Instead of using a time-averaged power P_{average} of the signals X(t) and Y(t) as in the formulas {1},-,{3} and {1′},-,{3′}, a different power related parameter may be used to define a scaling factor for scaling the power of the (degraded) output signal to a specific power level. This different power related parameter is called signal power activity (SPA). The signal power activity of a speech signal Z(t) is indicated as SPA(Z), meaning the total time duration during which the power of the signal Z(t) is at least equal to a predefined threshold power level Pₜₕᵣ.

A mathematical expression of the SPA of a signal Z(t) of total duration T is given by:

$$SPA ( Z ) = {\int }_{0}^{T} F ( t ) ⅆ t \qquad \{ 5 \} ,$$

in which F(t) is a step function as follows:

$$F ( t ) = \{ \begin{matrix}1 & for all 0 \leq t \leq T for which P ( Z ( t ) ) \geq {P}_{tr} \\ 0 & for all 0 \leq t \leq T for which P ( Z ( t ) ) < {P}_{tr}\end{matrix}$$

In this P(Z(t)) indicates the momentaneous power of the signal Z(t) at the time t, and Pₜᵣ indicates a predefined threshold value for the signal power. The expression {5} for the SPA is suitable for cases of a continuous signal processing. An expression which is suitable in cases of a discrete signal processing using time frames is given by:

$$SPA ( Z ) = {\sum }_{i = 1}^{N} F ( {t}_{i} ) \qquad \{ {5}^{′} \} ,$$

in which F(tᵢ) is a step function as follows:

$$F ( {t}_{i} ) = \{ \begin{matrix}1 & if P ( Z ( t ) ) \geq {P}_{{t}_{r}} for any t with {t}_{l - 1} < t \leq {t}_{i} \\ 0 & if P ( Z ( t ) ) < {P}_{tr} for all t with {t}_{i - 1} < t \leq {t}_{i}\end{matrix}$$

and in which tᵢ=(i/N)T for i=1,-,N and t₀=0, and N is the total number of time frames in which the signal Z(t) is divided for being processed. Calling a time frame for which F(tᵢ)=1 an active frame, then formula {5′} counts the total number of active frames in the signal Z(t).

Using the power related parameter SPA thus defined, new scaling factors are defined in a similar way as the scaling factors of formulas {1},-,{3}, {1′},-,{3′} and {4}, either to replace them, or to be used in multiplication with them. These new scaling factors are as follows:

T₁=T(X,Y)=SPA(X) /SPA(Y) {6.1}

T₂₌T(SPA_{f},X)=SPA_{fixed}/SPA(X) {6.2}

T₃=T(SPA_{f},Y)=SPA_{fixed}/SPA(Y) {6.3}

T′₁=T(Y+Δ)={SPA(X)+Δ}/{SPA(Y)+Δ} {6.1}

T′₂=T(X+Δ)=SPA_{fixed}/{SPA(X)+Δ} {6.2′}

T′₃=T(Y+Δ)=SPA_{fixed}/{SPA(Y)+Δ} {6.3′},

and

T₄=T^{α}(Y+Δ) {6.4}

In this SPA_{fixed} (i.e. SPA_{f}) is a predefined signal power activity level, which may be chosen in a similar way as the predefined power level P_{fixed} mentioned before.

Since the thus defined scaling factors are also a function of a reciprocal value of a power related parameter, i.e. the parameter SPA, which under circumstances may also have values which are very small or even zero, the parameters a and A as used in the scaling factors of formulas {6.1′},-,{6.3′} and {6.4} are advantageous as much for a better controllability of the scaling operations. They are adjusted in a similar way as, but generally will differ from, the parameters as used in the scaling factors according to the formulas {1′},-,{3′} and {4}. E.g. in the latter case Δ has the dimension of power and should have a non-negligible value with respect to P_{average}(X) (in {1′} or to P_{fixed}(in {2′}) or {3′}), whereas in the former case Δ is a dimensionless number, which may be simply put to be equal to one.

Hereinafter a scaling factor based on the SPA of a speech signal is called a T-type scaling factor, while a scaling factor based on the P_{average} of a speech signal is called an S-type scaling factor.

A T-type scaling factor may be used instead of a corresponding S-type scaling factor in each of the scaling operations described with reference to the figures FIG. 1 up to FIG. 5, inclusive.

The use of a T-type scaling factor provides a solution for the problem of unreliable speech quality predictions in cases in which two different degraded speech signals, which are the output signals of two different speech signal processing systems under test, and which come from the same input reference signal, have the same value for the average power. If e.g. one of the signals has a relative large power during only a short time of the total speech signal duration and extremely low or zero power elsewhere, whereas the other signal has a relative low power during the total speech duration, then such degraded signals may result in mainly the same prediction of the speech quality, whereas they may differ considerably in the subjectively experienced speech quality. Using a T-type scaling factor in such cases, instead of an S-type scaling factor, will result in different, and consequently more reliable predictions. However, since it is also possible that such two different degraded speech signals, instead of having the same value for the average power, have the same value for the signal power activity, and consequently may also result in unreliable predictions, it will be advantageous to use a scaling factor which is a combination of an S-type and a T-type scaling factor.

Various combinations are possible, such as a linear combination or a product combination of different or equal powers of an S-type and a T-type scaling factor.

A preferred combination is the simple multiplication of one of the S-type scaling factors with its corresponding T-type scaling factor, as to define a corresponding U-type scaling factor as follows:

U₁=S₁·T₁, U₂=S₂·T₂, U₃=S₃·T₃, U′₁=S′₁·T′₁, U′₂=S′₂·T′₂, U′₃=S′₃·T′₃, and U₄=S₄·T₄.

Each of the thus defined U-type scaling factors is to be used instead of a corresponding S-type scaling factor in each of the scaling operations described with reference to the figures FIG. 1 up to FIG. 5, inclusive.

A second new scaling factor is a function of a reciprocal value of a still different power related parameter, i.e. the instantaneous power of a speech signal. More particularly it is derived from what may be called a local scaling factor, i.e. the ratio of the instantaneous powers of the reference and output signals. The second new scaling factor is achieved by averaging this local scaling factor over the total duration of the speech signal, in which the adjustment parameters α and Δ are introduced already on the local level. A thus achieved scaling factor, hereinafter called V-type scaling factor, may be applied in a scaling operation carried out in the signal combining section 50.3 of the measurement device 50, instead of or in combination with one of the scaling operations carried out by the scaling units 51 and 52 with a substantially unchanged scaling operation carried out by the scaling unit 42 in the pre-processing section 50.1. There exist various possibilities for carrying out a scaling operation based on the V-type scaling factor, depending on whether a local or a global version thereof is applied. Some of the possibilities are described now with reference to FIG. 6 and FIG. 7.

A local version V_{L} of the V-type scaling factor, in which already the two adjustment parameters have been introduced is given by the following mathematical expression:

$${V}_{L} = {V}^{{α}_{3}} ( Y + {Δ}_{3} , t ) = {( \frac{P ( X ( t ) ) + {Δ}_{3}}{P ( Y ( t ) ) + {Δ}_{3}} )}^{{α}_{3}}$$

in which P(X(t)) and P(Y(t)) are expressions for the instantaneous powers of the reference and degraded signal, respectively. The parameters α₃ and Δ₃ have a similar meaning as described before, but will have generally different values. This local version V_{L} is applied to the time-dependent differential signal D in a scaling unit 61 between the differentiating means 15 and the modelling means 16 in the combining section 50.3, possibly in combination with the scaling operation as carried out by the scaling unit 51. Thereby for the indicated averaging the averaging is used, which is implicit in the modelling means 16.

A global version V_{G} of the V-type scaling factor is derived by averaging the local version V_{L} over the total duration of the speech signal. Such averaging may be done in a direct way as follows:

$${V}_{G} = {V}^{{α}_{3}} ( Y + {Δ}_{3} ) = \frac{1}{T} {\int }_{0}^{T} {V}^{{α}_{3}} ( Y + {Δ}_{3} , t ) ⅆ t$$

The global version of the V-type scaling factor may be applied by a scaling unit 62 to the quality signal Q as outputted by the modelling means 16, resulting in a scaled quality signal Q′, possibly in combination with, i.e. followed (as shown in FIG. 7) or preceded by, the scaling operation as carried out by the scaling unit 52, resulting in a further scaled quality signal Q″. Otherwise the global version of the V-type scaling factor may be applied by the scaling unit 61, instead of the local version of the V-type scaling factor, to the differential signal D as outputted by the differentiating means 15, possibly in combination with, i.e. followed (as shown in FIG. 7) or preceded by, the scaling operation as carried out by the scaling unit 51.

The expressions {7.1} and {17.2} for the V-type scaling factors are again given for a continuous signal processing. Corresponding expressions suitable for cases of discrete signal processing may be obtained simply by replacing the various time-dependent signal functions by their discrete values per time frame and the integral operations by summing operations over the number of time frames.

The various suitable values for the parameters α₃ and Δ₃ are determined in a similar way as indicated above by using specific sets of test signals X(t) and Y(t) for a specific system under test, in such a way that the objectively measured qualities have high correlations with the subjectively perceived qualities obtained from mean opinion scores. Which of the versions of the V-type scaling factors and where applied in the combining section of the device, in combination with which one of the other types of scaling factors, should be determined separately for each specific system under test with corresponding sets of test signals. Anyhow the U-type scaling factor is more advantageous in cases of degraded speech signals with parts of extremely low or zero power of relative long duration, whereas the V-type scaling factor is more advantageous for such signals having similar parts of relative short duration.

1. Method for determining, according to an objective speech measurement technique, the quality of an output signal (Y(t)) of a speech signal processing system with respect to a reference signal (X(t)), which method comprises a main step of processing the output signal and the reference signal, and generating a quality signal (Q),
wherein the processing main step includes:
a first scaling step (S(Y+Δ); S(Y+Δᵢ), with i=1,2) for scaling a power level of at least one signal of the output and reference signals by applying a first scaling factor which is a function of a reciprocal value of a first power related parameter of the at least one signal, and
a second scaling step carried out by applying a second scaling factor (S^{α}(Y+Δ); S^{αi}(Y+Δᵢ), with i=1,2; V^{α3}(Y+Δ₃, t); V^{α3}(Y+Δ₃)) which is a function of a reciprocal value of a second power related parameter of the at least one signal, using at least one adjustment parameter (α,A; αᵢ,Δᵢ with i=1,2; α₃,Δ₃).

2. Method according to claim 1, wherein the reciprocal value of the second power related parameter is raised to an exponent with a value corresponding to a first adjustment parameter (α; αᵢ with i=1,2; α₃), the second power related parameter being increased with a value corresponding to a second adjustment parameter (Δ; Δᵢ with i=1,2; Δ₃).

3. Method according to claim 1 or 2, wherein the first scaling factor (S(Y+Δ); S(Y+Δᵢ), with i=1,2) is a function of the first power related parameter increased by a value corresponding to a third adjustment parameter (Δ; Δᵢ, with i=1,2).

4. Method according to any of the claims 1,-,3, wherein the second scaling step is carried out on the output and reference signals (Y_{S}(t), X_{S}(t)) as scaled in the first scaling step.

5. Method according to claim 4, wherein the first and second scaling steps are combined to a single scaling step by applying the product of the first and second scaling factors.

6. Method according to any of the claims 1,-,3, wherein the second scaling step is carried out on at least one of two signals, the two signals being a differential signal (D) as determined in a signal combining stage (50.3) of the processing main step and the quality signal (Q) as generated by the processing main step.

7. Method according to any of the claims 3,-,6, wherein the second scaling factor (S^{α}(Y+Δ); S^{αi}(Y+Δᵢ), with i=1,2) is derived from the first scaling factor (S(Y+Δ); S(Y+Δᵢ), with i=1,2), the first and second power related parameters being the same, and the second and third adjustment parameters being the same.

8. Method according to any of the claims 3,-,7, wherein the first power related parameter includes the average power of the output signal increased by an adjustment value corresponding to the third adjustment parameter (Δ;Δᵢ, with i=1,2).

9. Method according to claim 8, wherein increasing by said adjustment value is achieved by adding to the output signal (Y(t)) a noise signal having an average power corresponding to the third adjustment parameter (Δ; Δᵢ, with i=1,2).

10. Method according to any of the claims 1,-,7, wherein the first power related parameter includes a total time duration during which the power of the output signal is above or equal to a threshold value.

11. Method according to claim 10, wherein the total time duration in said first power related parameter is increased by a value corresponding to the third adjustment parameter (Δ; Δᵢ with i=1,2).

12. Method according to claim 10, wherein during the main processing step the reference and output signals are processed using time frames, and the total time duration in said first power related parameter is expressed by the total number of time frames during which the power of the reference and output signals is at least equal to the threshold value.

13. Method according to claim 12, wherein said total number of time frames is increased by a value corresponding to the third adjustment parameter (Δ; Δᵢ with i=1,2).

14. Method according to any of the claims 2,-,13, wherein the first adjustment parameter has a value between zero and one (α; αᵢ with i=1,2; α₃).

15. Method according to any of the claims 3,-,14, wherein in the first scaling step the reference signal (X(t)) is scaled by applying a third scaling factor (S(X+Δ); S(X+Δᵢ), with i=1,2) which is derived from the reference signal using the second adjustment parameter (Δ; Δᵢ, with i=1,2) in a similar way as the first scaling factor is derived.

16. Method according to any of the claims 2,-,12, wherein in the first scaling step the output signal (Y(t)) is scaled, the first scaling factor (S(Y+Δ); S(Y+Δᵢ), with i=1,2) being a multiplication of a fourth scaling factor and a fifth scaling factor, the fourth scaling factor being a function of the reciprocal value of the average power of the output signal increased by a first adjustment value corresponding to the second adjustment parameter (Δ;Δᵢ), and the fifth scaling factor being a function of the reciprocal value of the total time duration during which the power of the output signal is above or equal to the threshold value increased by a second adjustment value corresponding to the second adjustment parameter (Δ;Δᵢ).

17. Method according to claim 6, wherein the second power related parameter of the second scaling factor (V^{α3}(Y+Δ₃,t); V^{α3}(Y+Δ₃)) includes an instantaneous value of the power of the output signal increased by an adjustment value corresponding to the second adjustment parameter (Δ₃).

18. Method according to claim 17, wherein a local version (V^{α3}(Y+Δ₃,t)) of the second scaling factor is applied to the differential signal (D).

19. Method according to claim 17, wherein a global version (V^{α3}(Y+Δ₃)) of the second scaling factor is applied to the at least one of two signals (D; Q).

20. Method according to any of the claims 17-19, wherein the second scaling step is combined with a third scaling step by applying a third scaling factor (S^{α}(Y+Δ); S^{αi}(Y+Δᵢ) , with i=1,2) derived from the first scaling factor (S(Y+Δ); S(Y+Δᵢ), with i=1,2).

21. Device for determining, according to an objective speech measurement technique, the quality of an output signal (Y(t)) of a speech signal processing system (10) with respect to a reference signal (X(t)), which device comprises:
pre-processing means (12) for pre-processing the output and reference signals,
processing means (13, 14) for processing signals pre-processed by the pre-processing means and generating representation signals (R(Y), R(X)) representing the output and reference signals according to a perception model, and
signal combining means (15, 16) for combining the representation signals and generating a quality signal (Q),
the pre-processing means including first scaling means (21; 31, 32; 41, 42) for scaling a power level of at least one signal of the output and reference signals (Y(t), X(t)) by applying a first scaling factor (S(X,Y); (S(P_{f},Y); S(Y+Δ)), which is a function of a reciprocal value of a first power related parameter of the at least one signal,
wherein the device further comprises second scaling means (43, 44; 51; 52; 61; 62) for a scaling operation carried out by applying a second scaling factor (S^{α}(Y+Δ); S^{αi}(Y+Δᵢ), with i=1,2; V^{α3}(Y+Δ₃,t); V^{α3}(Y+Δ₃)), the second scaling factor being a function of a reciprocal value of a second power related parameter of the at least one signal, using at least one adjustment parameter (α,Δ; αᵢ,Δᵢ with i=1,2; α₃,Δ₃).

22. Device according to claim 21, wherein the second scaling means have been arranged for scaling by applying the second scaling factor as being a function of the reciprocal value of the second power related parameter raised to a first adjustment parameter (α; αᵢ with i=1,2; α₃), the second power related parameter being increased with a value corresponding to a second adjustment parameter (Δ; Δᵢ with i=1,2; Δ₃).

23. Device according to claim 21 or 22, wherein the first scaling means include a scaling unit (42) for scaling the output signal by applying the first scaling factor, the first scaling factor (S(Y+Δ); S(Y+Δᵢ), with i=1,2) being a function of the first power related parameter increased by a value corresponding to a third adjustment parameter (Δ; Δᵢ, with i=1,2).

24. Device according to any of the claims 21,-,23, wherein the second scaling means have been included in the pre-processing means for scaling the output and reference signals (Y_{S}(t), X_{S}(t)) as scaled in the first scaling step, by applying the second scaling factor.

25. Device according to any of the claims 21,-,23, wherein the signal combining means include:
differentiating means (15) for determining from the representation signals a differential signal (D),
modelling means (16) for processing the differential signal and generating the quality signal, and
the second scaling means for scaling one of two signals by applying the second scaling factor, the two signals being the differential signal (D) as determined by the differentiating means (15) and the quality signal (Q) as generated by modelling means (16).

26. Device according to any of the claims 21,-,25, wherein the second scaling means include at least one scaling unit (43, 44; 51; 52) coupled to the first scaling means (42) for receiving the first scaling factor and for applying the second scaling factor as derived from the first scaling factor.

27. Device according to claim 25, wherein the second scaling means include a scaling unit (61; 62) for scaling said one of two signals by applying the second scaling factor, the second power related parameter of the second scaling factor (V^{α3}(Y+Δ₃,t); V^{α3}(Y+Δ₃)) including an instantaneous value of the power of the output signal increased by an adjustment value corresponding to the second adjustment parameter (Δ₃).

28. Device according to claim 27, wherein the second scaling means have been combined with third scaling means, which include at least one scaling unit (51; 52) coupled to the first scaling means (42) for receiving the first scaling factor and for scaling said one of two signals (D; Q) by applying a third scaling factor (S^{αi}(Y+Δᵢ), with i=1,2), in combination with the second scaling factor, the third scaling factor being derived from the first scaling factor (S(Y+Δᵢ), with i=1,2).

29. Device according to any of the claims 21,-,28, wherein the first power related parameter of the first scaling factor includes an average power of the output signal.

30. Device according to any of the claims 21,-,29, wherein the first power related parameter includes a total time duration during which the power of the output signal is above or equal to a threshold value.
